(19) United States
(12) Patent Application Publication
(10) Pub. No.: US 2009/0100322 A1
(43) Pub. Date: Apr. 16, 2009

(54) RETRIEVING DATA RELATING TO A WEB PAGE PRIOR TO INITIATING VIEWING OF THE WEB PAGE

(75) Inventors: Anthony Howard Phillips, North Baddesley (GB); Timothy Edward Preece, Eastleigh (GB)

Correspondence Address: IBM CORPORATION, 3039 CORNWALLIS RD., DEPT. T81 / B503, PO BOX 12195, RESEARCH TRIANGLE PARK, NC, 27709, US

(73) Assignee: International Business Machines Corporation, Armonk, NY (US)

(21) Appl. No.: 12/199,083

(22) Filed: Aug. 27, 2008

(30) Foreign Application Priority Data
Oct. 11, 2007 (EP) 07118321.4

(51) Int. Cl. G06F 17/00

(52) U.S. Cl. 715/205

(57) ABSTRACT

Data is stored in a server database relating to the availability and/or technical requirements for accessing web pages accessible at specific URLs. When a user browses a web page that includes hyperlinks to one or more other pages, stored availability/technical requirements data is retrieved from the server database and presented to the user to enable the user to decide whether or not to attempt to access one or more of the hyperlinked pages. The stored data may be retrieved for all hyperlinks on a web page when the page is first presented to the user or may be retrieved for a particular hyperlink only when a user has tentatively selected the particular hyperlink by a user action such as hovering a pointer icon over the hyperlink.

### BACKGROUND OF THE INVENTION

The present invention relates to retrieving data relating to a web page prior to initiating viewing of the web page.

Web pages provided to client computers by web servers commonly include one or more links in the form of hyperlinks that link the web page to other web pages. Such links include network addresses in the form of Uniform Resource Locators (URLs) that enable the other web pages to be located and loaded onto the client computer over the network. When a user selects a given link, the linked web page is loaded.

One problem is that after a link has been selected, the web page indicated by the URL may not be available or may have one or more incompatible technical requirements that render the web browser application program on the client computer unable to display the web page. Having selected a web page that is not available or cannot be viewed due to a technical incompatibility, the user is forced to return to the previous web page to make an alternative selection or select another web page by alternative means. Either way, following links to unavailable or incompatible web pages wastes a user's time and reduces the quality of the user's browsing experience.

### BRIEF SUMMARY OF THE INVENTION

The invention may be implemented as a method for retrieving data relating to a web page prior to initiating viewing of the web page. A first web page with one or more links to one or more second web pages is accessed. A store of data elements relating to web pages is accessed and data elements in the store relating to one or more of the second web pages are identified. The identified data elements are presented to the user before the user initiates viewing of one of the second web pages via selection of one of the links appearing in the first web page.

The invention may also be implemented as an apparatus for retrieving data relating to a web page before initiating viewing of the web page. The apparatus includes a web browser for accessing a first web page having or one more links that can provide access to one or more second web pages. The apparatus also has an access component for accessing a store of data elements relating to one or more web pages and a receiving component for receiving data elements relating to one or more of the second web pages from the store. Finally, the apparatus includes a display component for presenting identified data elements to the user before the user can initiate viewing selection of a second web page via selection of one or more of the links.

The invention may also be implemented as a computer program product for retrieving data relating to a web page before viewing of the page is initiated. The computer program product includes a computer usable medium embodying computer usable program code that is configured to access a first web page that includes one or more links through which one of more second web pages can be accessed, computer usable program code configured to access a store of one or more data elements relating to web pages, computer usable program code configured to identify data elements in the store relating to one or more of the second pages for which links are provided on the first page, and computer usable program code configured to present identified data elements to a user when the data elements are related to one or more of the second web pages accessible via links on the first web page and before the user initiates viewing of the web pages.

### BRIEF DESCRIPTION OF THE SEVERAL VIEWS OF THE DRAWINGS

Embodiments of the invention will now be described, by way of example only, with reference to the accompanying drawings in which:

FIG. 1 is a schematic illustration of a computer system;

FIG. 2 is a schematic illustration of programs on a client computer in the system of FIG. 1;

FIG. 3 is a table illustrating data stored on a server computer in the system of FIG. 1;

FIG. 4 is a flow chart illustrating processing performed by the client computer when collecting the data of FIG. 3;

FIG. 5 is a flow chart illustrating processing performed by the client computer when retrieving the data of FIG. 3; and

FIG. 6 is a flow chart illustrating processing performed by the server computer on the data of FIG. 3.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer usable medium having computer usable program code embodied in the medium.

Any suitable computer usable medium or computer readable medium may be utilized. The computer usable or readable medium may be, for example but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer usable or readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer usable or computer readable medium may be any medium that can contain, store, communicate, propagate, or transport the program for use by or in connection with the instruction execution system, apparatus, or device. The computer usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer usable program code for carrying out operations of the present invention may be written in an object oriented programming language such as Java, Smalltalk, C++or the like. However, the computer usable program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

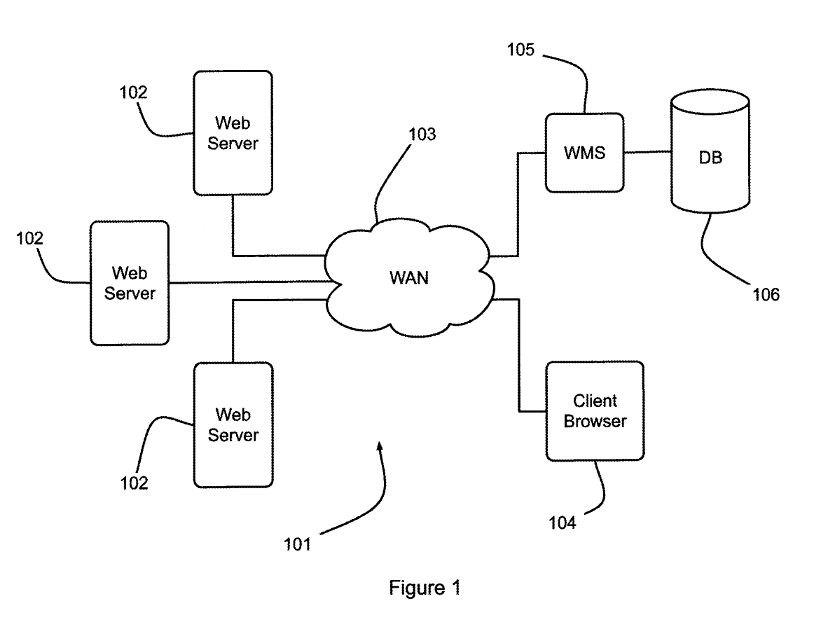

FIG. 1 shows a computer system 101 comprising a set of web server computers 102 interconnected by a network in the form of a wide area network (WAN) 103 such as the Internet. The web server computers 102 are arranged to run web server application programs which provide web sites in the form of sets of web pages. A client computer (client browser) 104 is also connected to the network 103. The client computer 104 is arranged to run a web browser application program that enables a user to view the web pages of the web sites provided by the web server computers 102.

At least some of the web pages on the web sites contain references to other web pages either on the same site or on another of the sites. The references are provided by links in the form of hyperlinks, each of which includes the network address for the linked web page. The network addresses are in the form of Uniform Resource Locators (URLs). User selection of such a link via the browser application program results in the linked web page being subsequently retrieved and displayed to the user.

The computer system 101 comprises a additional server computer 105 with a connected storage device 106. The additional server computer 105 is a Web Management System (WMS) server configured to run a WMS application program. The WMS server 105 is configured to receive and maintain a repository of data relating to web pages provided by the web servers 102. The data is stored in a database on the storage device 106 and is in the form of a set of data elements for one or more of the web pages. In the present embodiment, each such data element describes a technical requirement or access status for the web page. In other words, the WMS server 105 holds data on whether a web page is available for viewing and details of the technical settings of the web browser application program required to properly view the web page. The processing performed and the data stored by the WMS server 105 are described in further detail below.

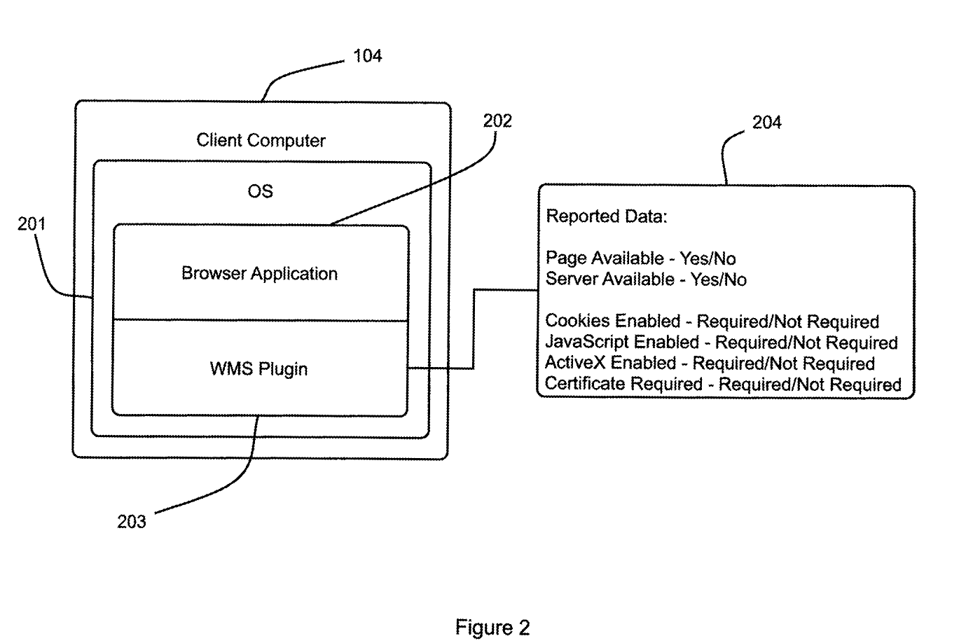

With reference to FIG. 2, the client computer 104 runs an operating system 201 on which the web browser application program 202 is installed. The web browser 202 further comprises an additional sub-program in the form of a WMS plugin 203. The WMS plugin 203 performs at least two functions in the present embodiment. First, the WMS plugin 203 is configured to collect a set of data 204 from each web page viewed or loaded via the web browser 202 and to send the collected data to the WMS server 105. The WMS server 105 is configured to store the set of data 204 on the storage device 106 as described above. Secondly, the WMS plugin 203 is configured, in response to the loading of a web page, to identify any links within the loaded page and to retrieve any sets of data 204 associated with those links that are stored by the WMS server 105. The sets of data are then analyzed with respect to the settings of the web browser 202. The results of the analysis presented to the user for a specific link in response to a predetermined user input or tentative selection relative to the specific link. In the present embodiment, the predetermined user input or tentative selection can take the form of the hovering of a pointer icon over a given link. In response to this user indication, the WMS plugin 203 displays the analysis results to the user in a text box superimposed on the web page.

In the present embodiment, the set of data 204 comprises a first set of data elements comprising status data for the web page accessible through the given link. The status data indicates whether or not the web page and its associated web server are available. A second set of data elements comprises technical requirements of the given web page. The technical requirements may determine whether or not a given web browser application program will be able to effectively display the page. In the present embodiment, the technical requirements of for a web page indicate whether or not cookies are accepted by a given web browser that will be used to view the web page, whether ActiveX™ or JavaScript™ components are required by that browser for the correct functioning of the web page and whether a certificate is required by the web site.

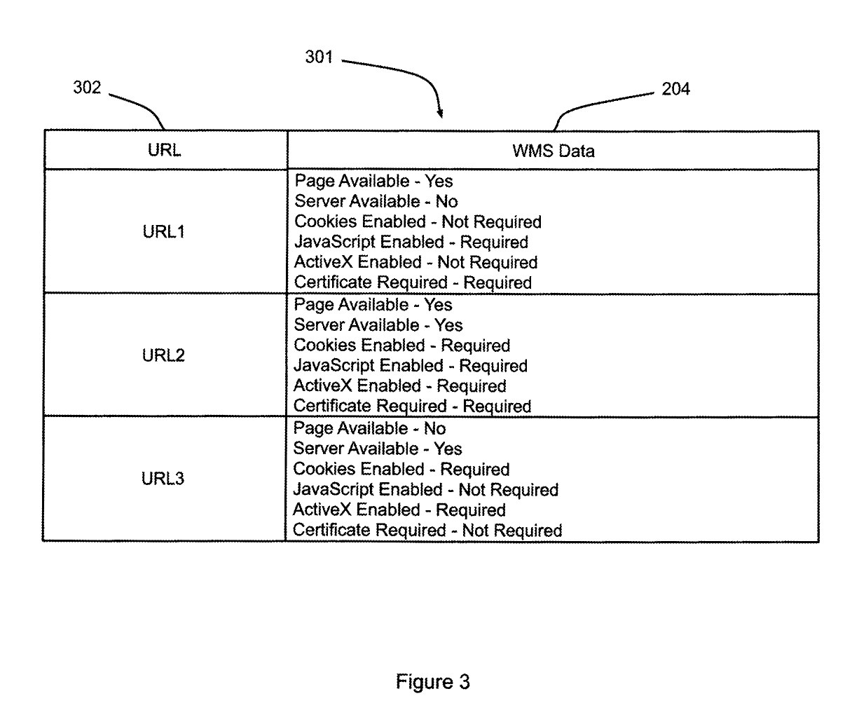

FIG. 3 illustrates a database structure 301 in which three sets of data 204 associated with different URLs are stored on the storage device 106 of the WMS server 105. The sets of data 204 are indexed by the URL 302 of the web page to which they refer. As shown in FIG. 3, each set of data 204 comprises the individual settings for a given web page that have been supplied to the WMS server 105 by a WMS plugin 203 associated with a web browser 202 that has loaded the given page.

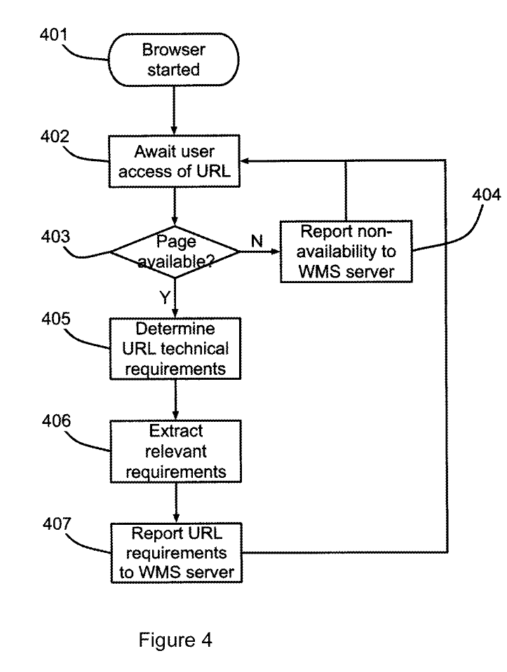

The processing performed by the WMS plugin 203 to provide the sets of data 204 will now be described with reference to the flow chart of FIG. 4. At step 401, the web browser 202 is started, initializing the WMS plugin 203. Processing moves to step 402. At step 402, further processing is deferred until a user attempts to access a URL. URLs may be accessed manually by a user or automatically by some element of programming such as a JavaScript™ program. Once such an access attempt is made, processing moves to step 403. At step 403, a check is performed to determine whether or not the web page for the entered URL is available. For example, a page may be unavailable because it has been moved or deleted from the web server or because the web server itself is unobtainable. If the page is unavailable, processing moves to step 404 where a set of data elements detailing the unavailability are reported to the WMS server 105 for the respective URL and processing returns to step 402 to await the accessing of a different URL.

If at step 403 the web page is available then processing moves to step 405 where the technical requirements for viewing or accessing the web page are extracted and processing moves to step 406. At step 406, the relevant elements of the technical requirements, as defined in the set of data 204, are extracted and processing moves to step 407. At step 407, the extracted set of data elements, including those indicating the availability of the web page, are reported to the WMS server 105 for the respective URL. Processing then returns to step 402 to await the access of a different URL as described above.

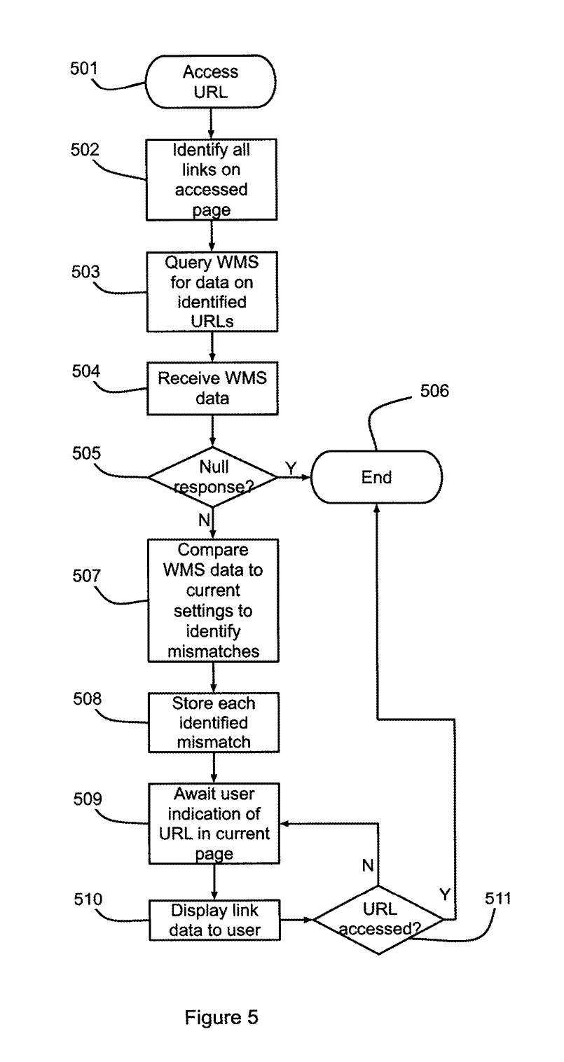

The processing performed by the WMS plugin 203 when retrieving and analyzing the set of data 204 for a given web page will now be described with reference to the flow chart of FIG. 5. At step 501, processing is initiated upon the accessing of a URL via the web browser 202. Once the page has successfully loaded, processing moves to step 502. At step 502, all the links on the loaded web page to other web pages are identified and their associated URLs identified. As will be understood by those skilled in the art, the URLs within a given page can be identified from a Document Object Model (DOM) created by the web browser when the given page is loaded. Processing then moves to step 503, where the WMS server 105 is queried for the sets of data 204 for each of the identified URLs in the loaded web page. Processing then moves to step 504 to await the receipts of each set of data 204 from the WMS server 105. Once a response is received, processing moves to step 505. At step 505, if the WMS server 105 supplies a null response, indicating that the WMS server 105 holds no data for the identified URLs then processing moves to step 506 and ends.

If at step 505 one or more sets of data 204 are received from the WMS server 105 then processing moves to step 507. At step 507, the technical requirements of each received set of data 204 are compared to the current settings of the web browser 202 and any incompatibilities or mismatches are identified. Processing then moves to step 508 where each identified incompatibility or mismatch is stored against the relevant link. Processing then moves to step 509 where tentative selection of one of the links in the loaded page is detected. As noted earlier, the tentative selection will be considered to have occurred when the user hovers a pointer icon or cursor over the displayed link. When a tentative selection indication is provided, processing moves to step 510 where data collected for the relevant link, such as access status data and technical requirement incompatibility data, is displayed to the user in a pop-up text box. Once the selection indication ends, either by the user moving the pointing device away from the displayed link or by the user actually selecting the link (for example, by clicking a button on the pointing device) , processing moves to step 511. If at step 511 the user has moved the pointing device away from the relevant link, processing returns to step 509 to await a further user tentative selection indication as described above. If at step 511 the user has actually selected the link then processing moves to step 506 where processing ends.

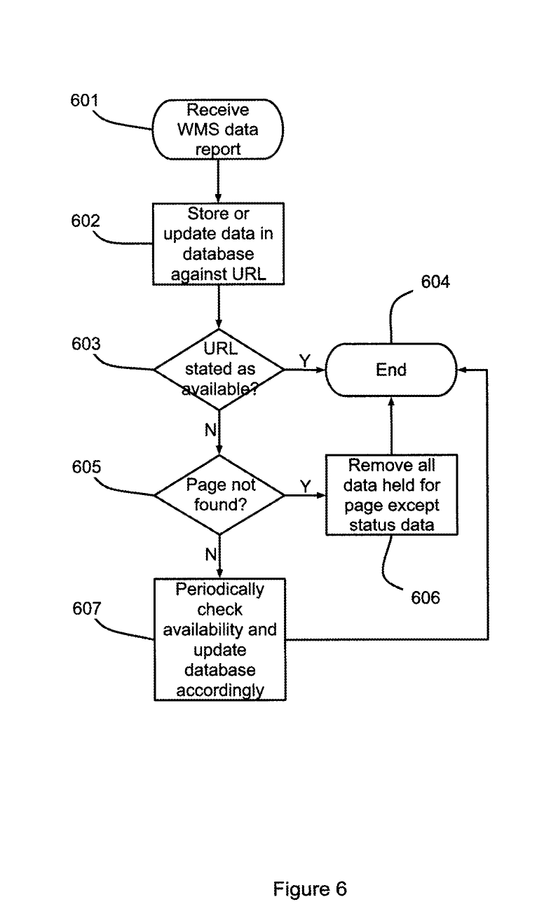

The processing performed by the WMS server 105 when maintaining elements of the sets of data 204 will now be described with reference to the flow chart of FIG. 6. At step 601, processing is initiated upon receipt of a set of data 204 for a given URL from a WMS plugin 203 in client computer 104 and processing moves to step 602. At step 602, either the current entry for the given URL is updated with the new set of data 204 or a new entry is created for the given URL. Processing then moves to step 603 where the status data for the new or updated entry is inspected and if the web page is indicated as available then processing moves to step 604 and ends. If at step 603 the status data indicates that the relevant web page is unavailable then processing moves to step 605 where the status data is used to determine whether the page is unavailable because it was not found or because the web server providing the page could not be contacted. If the page could not be found, presumably because it has been moved or deleted, then processing moves to step 606. At step 606 all of the data for the URL except the page status data is removed from the WMS server as it is no longer relevant.

If at step 605 it is determined that the page is unavailable because the corresponding web server cannot be contacted then processing moves to step 607. At step 607 a process is initiated to periodically check the status of the server and to update the status data accordingly if the server becomes available. When the server has been reported as available, processing moves to step 604 and ends. As will be appreciated by those skilled in the art, the WMS server 105 is arranged to simultaneously process one or more data updates and monitor the availability of one or more web servers.

Thus, if a user hovers the pointer icon over a link in a web page loaded in a window of the web browser, the user is provided with data on the web page accessible via the link. The provided data may influence the user's decision on whether or not to attempt to access the given web page. If, for example, the link is to a web page having URL1 as shown in FIG. 3, then the user will be informed that while the linked page may be available, the web server that provides it is currently unavailable. Furthermore, any mismatch between the settings of the web browser and the technical requirements for URL1 will be highlighted to the user. For example if the user's web browser has the JavaScript™ setting disabled or does not hold an appropriate access certificate for the web page then these facts will be presented to the user in order to help the user decide whether or not to select the link for URL1.

In a further embodiment, the WMS plugin is arranged to automatically disable a given link if its status data indicates that the referenced web page or server is unavailable. In another embodiment the WMS plugin is arranged to solely collect data when accessing web pages for supply to the WMS server. In a further embodiment, the WMS plugin is arranged not to collect any data but only to retrieve data from the WMS server. In another embodiment, the WMS plugin is arranged to collect or retrieve data for a predetermined set of web pages or URLs.

In a further embodiment, additional information is collected by the WMS plugin in the form of website metadata such as page response times, web page contents synopsis or details of the facilities offered by a web page. In another embodiment only basic data is collected by the WMS server or supplied to the user by the WMS plugin. Basic data could be limited to just the technical requirements or just the access status of a given page. In a further embodiment the WMS plugin is arranged to collect all data available from the web pages that are accessed by the associated web browser and the WMS server is arranged to either store the whole set of data or to select a predetermined set of elements for storage. In another embodiment, the WMS plugin is arranged to report only the set of data relevant to its own settings or only its known settings conflicts. In a further embodiment, the WMS plugin makes a simple request to the WMS server for any data on a given URL and is supplied with all data that the WMS server holds on that URL. The WMS plugin is then arranged to filter or further process the received data as appropriate.

As will be understood by those skilled in the art, the WMS plugin may be arranged to present the data on a given link to a user in any suitable manner. For example the data may be presented in a pop-up window, as hover-text, or be illustrated by a change in the representation of the link in the web page. An unavailable web page may be indicated by a change in color or animation of the link or by the link being greyed or appearing crossed out.

In another embodiment, the WMS server is provided with publish threshold for some data elements such as access status data. For example, only when a given web page is reported as unavailable a predetermined number of times in a predetermined period is the web page access status data changed accordingly. In a further embodiment, response times of a given website may be provided to a user as web page metadata. Such response times may be based on a running median of the response times reported to the WMS server for a given web page. Instead of presenting actual response times or average response times to a user, the system may be arranged to present ranges of response times as named levels such as “slow”, “medium” or “fast”, or as a percentage of full speed. Such levels may be set at the WMS server or at the WMS plugin running in the client computer. In a further embodiment the WMS server may be arranged to omit the periodical checking and updating of web page access status data.

In another embodiment, the data stored by the WMS server is manually entered or provided by means other than reports from WMS plugins. The web pages may report data directly to the WMS server or the WMS server may be arranged to automatically retrieve the data from web pages or web sites.

In a further embodiment, the WMS plugin is arranged to retrieve the data from the WMS server for a given link only when the user provides an indication of a link, such as hovering the pointer icon over the link.

In another embodiment, the database that stores the WMS data is partitioned, with each partition being used to store WMS data relating to URL from a predetermined geographic area. For example data for USA-origin websites may be stored in a separate partition for that of UK-origin websites. The database may be partitioned on other characteristics such as alphabetical partitions of domain names.

In a further embodiment, the WMS plugin is arranged to maintain a cache of the received WMS data for a predetermined period, thus reducing the unnecessary re-fetching of unaltered data from the WMS server in response to multiple visits to the same page within the predetermined period.

In another embodiment, the WMS is arranged to record time stamps with the WMS data and to send these to the web browser so as to provide the user with an indication of how current the accompanying WMS data is.

In a further embodiment, the WMS plugin is arranged to compare the WMS data received when a user indicated a given link with the actual data for the page when it is actually accessed and loaded. If the WMS data is accurate, then the WMS plugin is arranged not to send an update for that page to the WMS server. This feature reduces unnecessary updates to the WMS server.

In another embodiment, the WMS server and plugin are arranged to collect and provide data only for top-level domains and will not typically maintain WMS data for pages or subsections of a given web site.

As will be understood by those skilled in the art, the functionality of the WMS plugin and the WMS server application program may be provided by the same application program or may be provided by separate programs on the same programmable device. Furthermore, the functionality of the WMS plugin may by included within any suitable web browser application program.

As will be understood by those skilled in the art, the data collected and stored by the WMS plugin and WMS server application program is not intended to be limited to the examples described above. Any technical data relating to compatibility or other issues between the web page and the browser may be included, any status data relating to the current web page such as response time, page not found, web server unavailable, other users logged on to the page and so on. Furthermore any further data in the form of web page metadata may be provided to the user by the WMS server. In summary, any data that may influence a user's decision whether or not to select a given link and access the corresponding web page may be collected and provided by the WMS system.

It will be clear to one of ordinary skill in the art that all or part of the method of the preferred embodiments of the present invention may suitably and usefully be embodied in a logic apparatus, or a plurality of logic apparatus, comprising logic elements arranged to perform the steps of the method and that such logic elements may comprise hardware components, firmware components or a combination thereof.

It will be equally clear to one of skill in the art that all or part of a logic arrangement according to the preferred embodiments of the present invention may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

It will be appreciated that the method and arrangement described above may also suitably be carried out fully or partially in software running on one or more processors (not shown in the figures), and that the software may be provided in the form of one or more computer program elements carried on any suitable data-carrier (also not shown in the figures) such as a magnetic or optical disk or the like. Channels for the transmission of data may likewise comprise storage media of all descriptions as well as signal-carrying media, such as wired or wireless signal-carrying media.

The present invention may further suitably be embodied as a computer program product for use with a computer system. Such an implementation may comprise a series of computer-readable instructions either fixed on a tangible medium, such as a computer readable medium, for example, diskette, CD-ROM, ROM, or hard disk, or transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

In an alternative, the preferred embodiment of the present invention may be realized in the form of computer implemented method of deploying a service comprising steps of deploying computer program code operable to, when deployed into a computer infrastructure and executed thereon, cause said computer system to perform all the steps of the described method.

It will be clear to one skilled in the art that many improvements and modifications can be made to the foregoing exemplary embodiment without departing from the scope of the present invention.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method for retrieving data relating to a web page prior to initiating viewing of said web page, said method comprising:
accessing a first web page including one or more links for providing access to one or more second web pages;
accessing a store of data elements relating to one or more web pages;
identifying data elements in said store related to one or more of said second web pages accessible via said one or more links on said first web page; and
presenting said identified data elements to said user prior to said user initiating viewing of said second web page via selection of one of said one or more links.

2. A method according to claim 1 comprising the further steps of:
in response to said accessing of said first web page, identifying one or more predetermined data elements relating to said first web page; and
sending a record of said data elements to said store in relation to said first web page.

3. A method according to claim 1 in which said links are hyperlinks, each comprising a Uniform Resource Locator (URL), and said data elements relating to a given second web page in said store are indexed by the URL for said given second web page.

4. A method according to claim 3 wherein presenting said identified data elements further comprises presenting data relating to one or more technical requirements for viewing one or more of said second web pages.

5 . A method according to claim 4 further comprising:
comparing said technical requirements to the settings of the application program through which a given second web page may be viewed; and
presenting any incompatibilities between said technical requirements and said settings to said user.

6. A method according to claim 4 wherein presenting said identified data elements further comprises presenting data representing the status of one or more of said second web pages.

7. A method according to claim 4 wherein presenting said identified data elements further comprises presenting metadata relating to one or more of said second web pages.

8. A method according to claim 6 wherein accessing a store of data elements is initiated in response to the accessing of said first web page.

9 Apparatus for retrieving data relating to a web page prior to initiating viewing of said web page, said apparatus comprising:
a web browser for accessing a first web page comprising one or more links for providing access to one or more second web pages;
an access component for accessing a store of data elements relating to one or more web pages;
a receiving component for receiving data elements in said store related to one or more of said second web pages; and
a display component for presenting said identified data elements to said user prior to said user initiating viewing of said second web page via selection of one of said one or more links.

10. An apparatus according to claim 9 wherein said access component further comprises:
a logic component for identifying one or more predetermined data elements relating to said first web page in response to said accessing of said first web page; and
a transmitter component for sending a record of said one or more predetermined data elements to said store.

11. An apparatus according to claim 9 in which said links are hyperlinks, each comprising a Uniform Resource Locator (URL), and said data elements relating to a given second web page in said store are indexed by the URL for said given second web page.

12. An apparatus according to claim 11 in which said data elements comprise data relating to one or more technical requirements for viewing one or more of said second web pages.

13. An apparatus according to claim 11 in which said data elements comprise data relating to the status of one or more of said second web pages.

14. A computer program product for retrieving data relating to a web page prior to initiating viewing of said web page, said computer program product comprising a computer usable medium having computer usable program code embodied therewith, said computer usable program code comprising:
computer usable program code configured to access a first web page including one or more links for providing access to one or more second web pages;
computer usable program code configured to access a store of data elements relating to one or more web pages;
computer usable program code configured to identify data elements in said store related to one or more of said second web pages accessible via said one or more links on said first web page; and
computer usable program code configured to present said identified data elements to said user prior to said user initiating viewing of said second web page via selection of one of said one or more links.

15. A computer program product according to claim 14 further comprising:
computer usable program code configured to, in response to said accessing of said first web page, identify one or more predetermined data elements relating to said first web page; and
computer usable program code configured to send a record of said data elements to said store in relation to said first web page.

16. A computer program product according to claim 14 in which said links are hyperlinks, each comprising a Uniform Resource Locator (URL), and said data elements relating to a given second web page in said store are indexed by the URL for said given second web page.

17. A computer program product according to claim 16 wherein said computer usable program code configured to present said identified data elements further comprises computer usable program code configured to present data relating to one or more technical requirements for viewing one or more of said second web pages.

18. A computer program product according to claim 17 further comprising:
computer usable program code configured to compare said technical requirements to the settings of the application program through which a given second web page may be viewed; and
computer usable program code configured to present any incompatibilities between said technical requirements and said settings to said user.

19. A computer program product according to claim 16 wherein said computer usable program code configured to present said identified data elements further comprises computer usable program code configured to present data representing the status of one or more of said second web pages.

20. A computer program product according to claim 14 wherein said computer usable program code configured to access a store of data elements further comprises computer usable program code configured to initiated the access in response to the accessing of said first web page.
